(19) United States
(12) Patent Application Publication
(10) Pub. No.: US 2015/0232668 A1
(43) Pub. Date: Aug. 20, 2015

(54) Yellow Reactive Dye Compound

(71) Applicant: ZHEJIANG KEYONG CHEMICAL CO., LTD., Zhejing (CN)

(72) Inventors: Xiaohong Wang, Zhejiang (CN); Qi Ou, Zhejiang (CN); Renliang Wang, Zhejiang (CN); Jianjun Lv, Zhejiang (CN)

(21) Appl. No.: 14/431,045

(22) PCT Filed: Oct. 18, 2013
(86) PCT No.: PCT/CN2013/001255

§ 371 Date: Mar. 25, 2015

(30) Foreign Application Priority Data
Oct. 18, 2012 (CN) 201210401056.9
Aug. 7, 2013 (CN) 201310342878.9

(51) Int. Cl. C09B 35/378

(52) U.S. Cl. CPC C09B 35/378

(57) ABSTRACT

Provided in the present invention is a reactive yellow dye compound having a hydrazone structure, the structure of said compound being shown in formula (I). The reactive dye compound of the present invention can be applied during printing and dyeing to fibrous materials such as cellulose fibers and polyamide fibers, has outstanding sweat resistance and light resistance, exhibits a high rate of dye uptake and color fixation, has excellent build-up properties, promotes even dyeing and dye-color stability and is bright and rich in color.

### FIELD OF THE INVENTION

The present invention relates to yellow reactive dye compounds which have a hydrazone structure.

### BACKGROUND OF THE INVENTION

In the dyeing process, reactive dyes can not only covalently bond with the fiber, but also react with the medium, especially with a aqueous solution to produce hydrolyzed dyes which cannot covalently bond with the fiber, thus leading to a low fixation rate generally between 50% and 80%. This results in a waste of resources, and a reduction on color fastnesses, especially wet fastnesses of the textile. The unfixed dyes will cause severe environment pollution when they enter waste water.

In addition, as people's requirement for eco-environmental performance of the textile improves, there consequently exists a higher demand for fastness of reactive dyes to perspiration-light. When people dressed work or exercise outdoors, they tend to sweat a lot, and the textile is soaked with perspiration and also exposes to the burning sun, therefore the fading degree of the textile resulting from both perspiration and light is more serious than that affected by perspiration or light alone. Besides, the dyes and reaction byproducts got off from the textile will directly contact with skin, thus resulting in a security threat to human body. Currently, the problem of fastness of reactive dyes to perspiration-light for cotton is outstanding.

### SUMMARY OF THE INVENTION

The object of the present invention is to provide novel and economical yellow reactive dye compounds having a hydrazone structure. The compounds not only have excellent fastness to perspiration-light, but also a very high fixation rate, good deep-dyeing property, good dyeing levelness and wet fastnesses, and the unfixed portions can easily be washed off.

The technical solution of the present invention is as follows:

Yellow reactive dye compounds of formula (I):

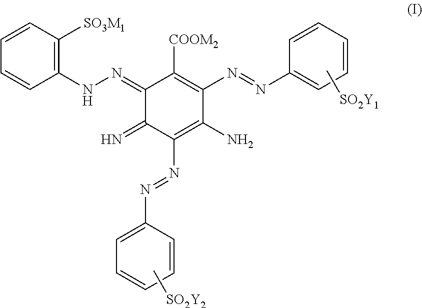

in which, Y₁ and Y₂ independently of one another are —CH═CH₂ or —C₂H₄OSO₃M₁, M₁ and M₂ independently of one another are H or an alkali metal.

Preferably, —SO₂Y₁ and —SO₂Y₂ independently of one another are at the meta or para position.

More preferably, the compounds have one of the following formulas:

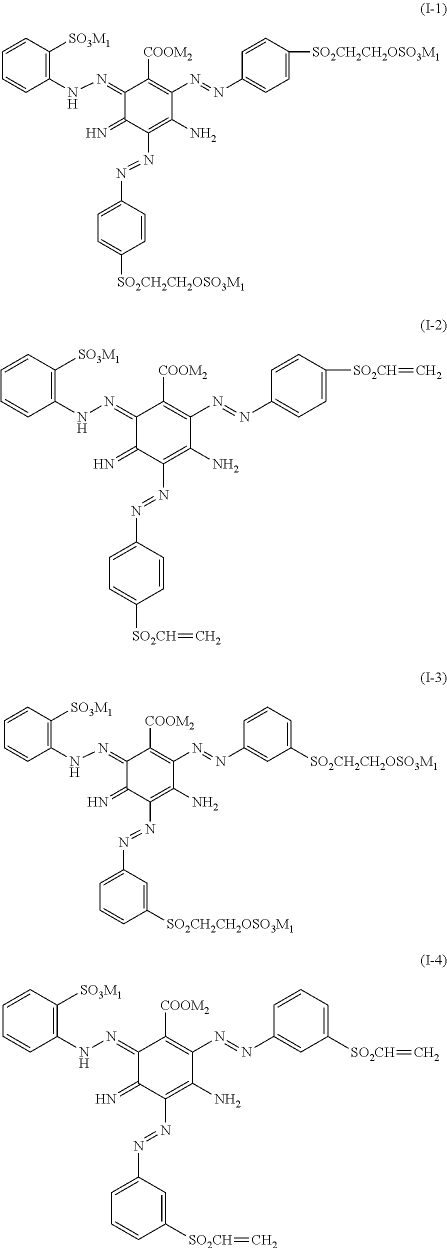

in which, M₁ and M₂ independently of one another are H or an alkali metal.

M₁ and M₂ are preferably H, Li, Na or K, more preferably H or Na.

The present invention also relates to a method for preparing the yellow reactive dye compounds. The yellow reactive dye compounds of formula (I) according to the present invention can be prepared in the form of free acid (i.e. M is H) or preferably in the form of an alkali metal salt (i.e. M is an alkali metal). According to the conventional method, the free acid form can be easily converted to the alkali metal salt form, and vice versa. The alkali metal salt may be lithium salt, sodium salt or potassium salt. Specifically, the method includes the following steps: diazotizing compounds of formulas (a), (b) and (c) with sodium nitrite at a temperature between 0° C. and 10° C. in the presence of hydrochloric acid according to the conventional method in the art, then coupling the resulting diazonium compounds to a compound of formula (d) at a pH ranging from 2 to 7 to obtain a yellow reactive dye compound of formula (I);

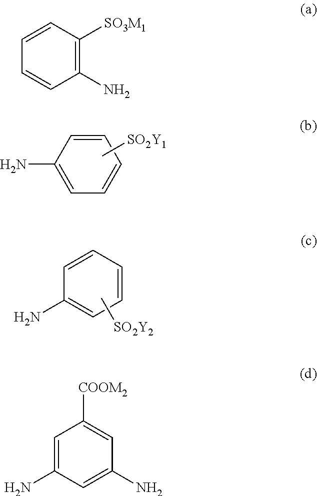

in which:

Y₁ and Y₂ independently of one another are —CH═CH₂ or —C₂H₄OSO₃M₁, M₁ and M₂ independently of one another are H or an alkali metal, the alkali metal is selected from Li, Na or K. M₁ and M₂ are preferably H or Na. Specifically, the method is carried out as follows:

(1) Diazotization: adding a compound of formula (a) into water, stirring the mixture well, cooling the mixture to a temperature ranging from 0° C. to 5° C., adding hydrochloric acid to the mixture, then slowly adding an aqueous solution of sodium nitrite dropwise to the mixture at 0° C. to 5° C., stirring the mixture at 0° C. to 5° C. for 0.5 to 2 hours, and then eliminating excess sodium nitrite with sulfamic acid to obtain the diazonium salt of the compound of formula (a);

(2) Diazotization: adding a compound of formulas (b) or (c) into water, stirring the mixture well, cooling the mixture to a temperature ranging from 0° C. to 5° C. , then slowly adding hydrochloric acid and sodium nitrite dropwise to the mixture at 0° C. to 5° C., stirring the mixture at 0° C. to 5° C. for 0.5 to 2 hours, then eliminating excess sodium nitrite with sulfamic acid to obtain the diazonium salt of the compound of formula (b) or (c); in which, the compound of formulas (b) is preferably structurally identical to the compound of formula (c);

(3) the first coupling reaction: adding a compound of formula (d) into water, after the compound of formula (d) dissolves, adding the diazonium salt obtained according to step (1) to the solution, then adjusting the pH of the mixture to 5.3 to 6.5, and carrying out coupling reaction at a temperature not higher than 8° C. for 2 to 5 hours to give a solution of the first coupling reaction;

(4) the second coupling reaction: quickly adding the diazonium salts of the compounds of formulas (b) and (c) obtained according to step (2) dropwise to the solution of the first coupling reaction obtained according to step (3), stirring the mixture until clear, then adjusting the pH of the mixture to 5.0 to 7.0, carrying out coupling reaction at 5° C. to 15° C. for 4 to 10 hours to give a solution of the second coupling reaction, and drying the solution to give a compound of formula (I) with a hydrazone structure.

The compounds of formulas (a) to (d) are known dye intermediates, which can be conveniently prepared or are commercially available. The dye compounds of formula (I) prepared according to the present invention may be separated according to the known methods, for example, by salting out with an alkali metal salt (preferably sodium salt or potassium salt), filtering and drying.

It should be noted that in the process of preparing the compounds of formula (I) according to the present invention, the product may comprise one or more byproducts of formulas (II) to (VI) which need not be separated from the product and can be applied to colouration of the fiber material together with the dye of formula (I):

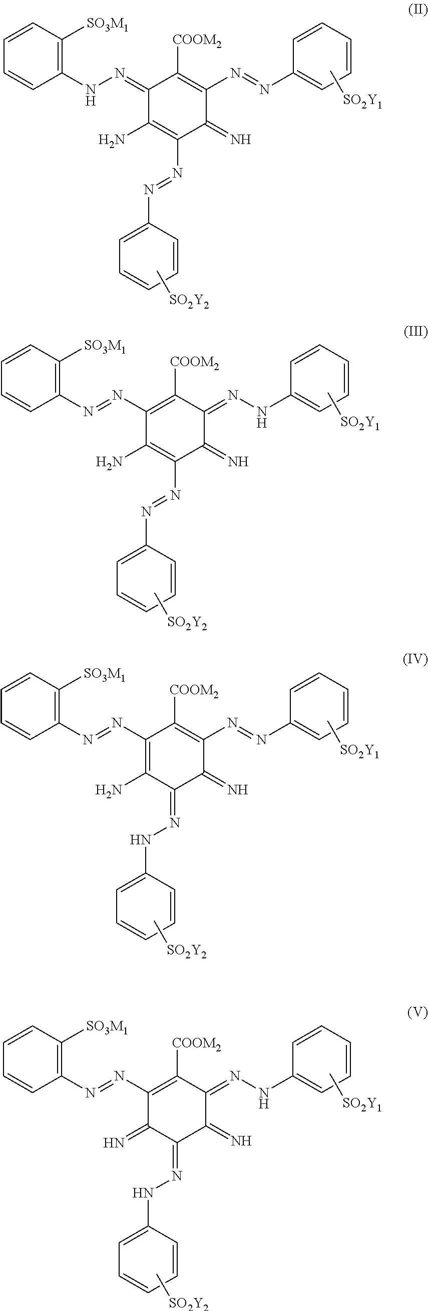

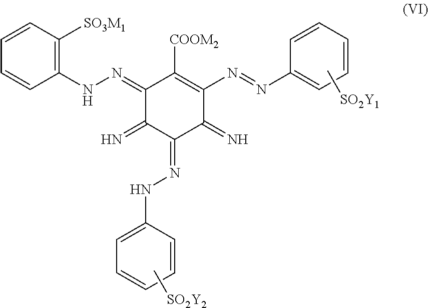

In the above formulas (II) to (VI), Y₁ and Y₂ independently of one another are —CH═CH₂ or —C₂H₄OSO₃M₁, M₁ and M₂ independently of one another are H or an alkali metal, and the alkali metal is selected from Li, Na or K. —SO₂Y₁ and —SO₂Y₂ are preferably at the meta or para position, and M₁ and M₂ are preferably H or Na.

The dye products prepared using the compounds of formula (I) of the present invention can be present in the form of solid particles, powders or liquid, and generally contain the electrolyte salts customary in the synthesis of reactive dyes, such as sodium chloride, potassium chloride and sodium sulfate. The dyes in solid form may further contain the auxiliaries customary in commercial dyes, such as buffer substances capable of setting a pH in aqueous solution between 3 and 7, such as sodium borate, sodium bicarbonate, sodium citrate, sodium phosphate monobasic and sodium phosphate dibasic, and small amounts of siccatives, or, if present in liquid or aqueous solution, they may include a content of thickeners of the type customary in print pastes.

The reactive dye compounds of the present invention are suitable for printing and dyeing cellulose fibers, polyamide fibers and their fabrics, wherein, the cellulose fibers are preferably cotton fibers and regenerated fibers, but also other vegetable fibers, such as bast fibers or fabrics; polyamide fibers are preferably animal fiber materials including leather, wool or silk, and synthetic fiber materials such as nylon 6, nylon 66, etc. The reactive dyes of the present invention can be applied to the above-mentioned fiber materials by following the dyeing methods known for reactive dyes, such as common exhaust dyeing method and padr dyeing method. The exhaust dyeing method is a method to introduce the fabric into the dye bath and dye the fabric with the dye gradually, and usually contains the following procedures: dyeing—fixing—water washing—soap boiling—water washing—dehydrating—drying. The pad dyeing method is a method to introduce the fabric into the dye bath, then let the fabric pass through rollers, which allows the dye liquor to penetrate the fabric uniformly, and finally subject the fabric to steaming or hot-melting and the like, and usually contains the following procedures: padding with a dye bath—drying—padding with a fix solution—steaming or baking—water washing—soap washing—water washing—drying .

Generally, due to the different requirements of the shade and color depth on the fabric, the amount of the dye used also varies. When the exhaust dyeing method is used, the dye depth is generally 0.1% to 10% (i.e. the dye accounts for 0.1 wt. % to 10 wt. % of the fabric weight), the bath ratio is 1:2 to 1:60, preferably 1:10 to 1:30, initial dyeing temperature is controlled at 30° C. to 60° C., the dyeing time is 10 min to 30 min, the soap boiling temperature is between 85° C. and 95° C., the soap boiling time is 10 min to 15 min, the fixing temperature is between 60° C. and 100° C., the fixing time is 10min to 50 min, and the fixing is carried out at a pH of 9 to 11. When the pad dyeing method is used, the pick-up of the cellulose fiber is generally 60% to 80% (i.e. after padding, the weight of the treated cellulose fiber is 1.60 to 1.80 times of the original cellulose fiber), the steaming temperature is 100° C. to 103° C., and the steaming time is 1 min to 3 min. Among the pad dyeing methods, the cold pad-batch dyeing method is usually used at present, which is a method to introduce the dye and an alkaline substance or alkaline substances to a padding machine, then wind the fabric at room temperature and batch for 2 to 30 hours, and finally rinse the fabric thoroughly.

The reactive dye compounds of the present invention, when used for printing and dyeing fiber materials such as cellulose fibers, polyamide fibers and the like, exhibit excellent fastness to perspiration-light, high dye-uptake rate, high fixation rate, and good performances of build-up, dyeing levelness and stability, and the shade obtained is bright and rich.

### BRIEF DESCRIPTION OF THE DRAWINGS

FIG. 1 is ¹H NMR spectrum of the compound of example 1;

FIG. 2 is COSY spectrum of the compound of example 1.

### EMBODIMENTS

The present invention is further described with specific embodiments, although the scope of the invention is not limited thereto:

In the embodiments, the dye compounds characterized by chemical formulas are in the form of free acids. However, it should be noted that they are usually prepared and separated in the form of an alkali metal salt, preferably in the form of lithium salt, sodium salt or potassium salt, and used for dyeing in the form of salt as well. Similarly, in the following examples, the starting compounds used in the synthesis can be in the form of free acid or an alkali metal salt.

### EXAMPLE 1

(1) Diazotization of aniline-2-sulfonic acid: 9.6 g of aniline-2-sulfonic acid was added into 40 mL of water, the resulting mixture was well stirred and cooled to 0° C. to 5° C. with ice, 6.5 g of 31% (w/w) hydrochloric acid was then added, then 13.1 g of 30% (w/w) sodium nitrite solution was slowly added dropwise at 0° C. to 5° C., the pH of the mixture was controlled at 1.0 to 1.2, the reaction took 1.5 to 2 hours during which the potassium iodide test paper maintained a blue color, and excess sodium nitrite was eliminated with sulfamate acid to obtain a diazonium salt solution of aniline-2-sulfonic acid;

(2) Diazotization of Para Base Ester: 31.4 g of Para Base Ester (i.e. p-((β-sulfato ethyl sulfonyl) aniline) was added into 50 mL of water, the resulting mixture was well stirred and then cooled to 0° C. to 5° C. with ice, 11.5 g of 31% hydrochloric acid and 26 g of 30% sodium nitrite solution were added at 0° C. to 5° C., then the reaction was carried out for 1 hour while maintaining a temperatue of 0° C. to 5° C., a pH of ≦1.2, and KI test paper in a blue color, and finally excess sodium nitrite was eliminated with sulfamic acid to give a diazonium salt solution of Para Base Ester;

(3) the first coupling reaction: 8.5 g of 3,5-diaminobenzoic acid was added into 30 mL of water, after stirring well, the pH of the mixture was adjusted to 8.0 to 8.5 with sodium bicarbonate, stirred the mixture for 2 hours until 3,5-diaminobenzoic acid almost dissolved, then the diazonium salt solution of aniline-2-sulfonic acid obtained according to step (1) was added to the solution within 15min to 30 min, the temperature was maintained at ≦5° C. with ice, the pH was adjusted to 5.8 to 6.2, and this was followed by reacting for 3 hours until 3,5-diaminobenzoic acid almost disappeared to give a solution of the first coupling reaction;

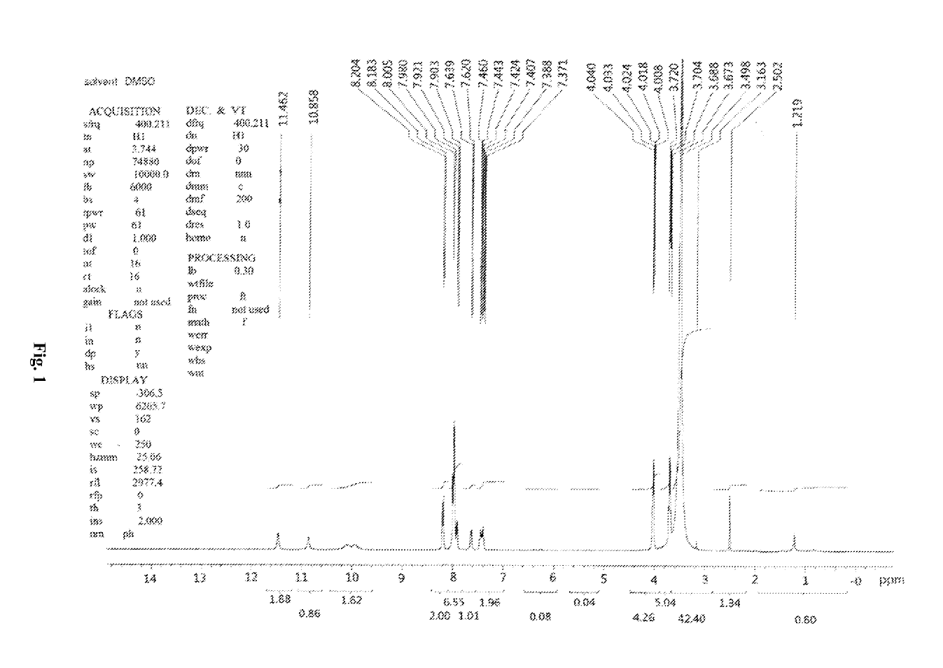

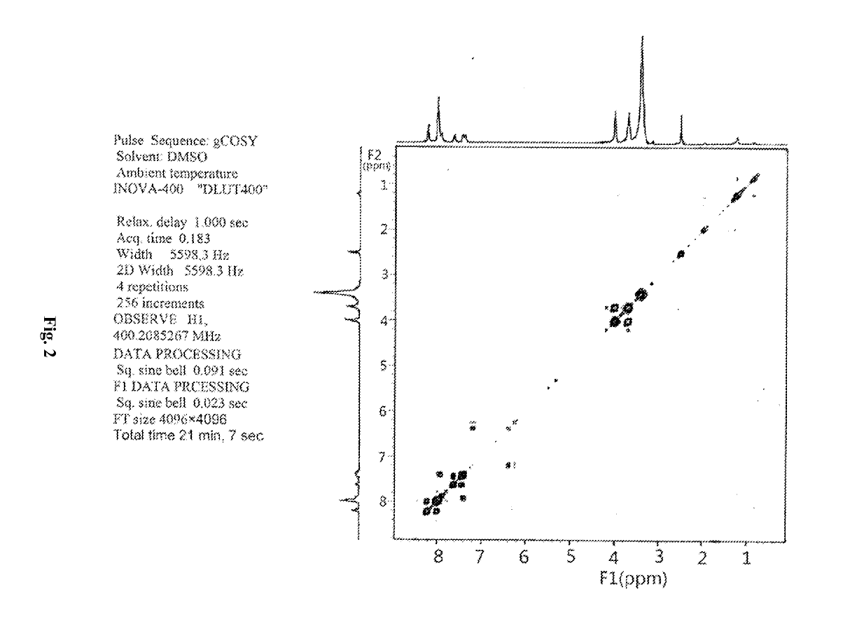

(4) the second coupling reaction: the diazonium salt solution of Para Base Ester obtained according to step (2) was rapidly added drop-wise to the solution of the first coupling reaction obtained according to step (3), the pH of the mixture was controlled at 0.8 to 1.1 and the temperature was at 9° C. to 13° C., the resulting mixture was stirred until completely clear, then the pH was slowly adjusted to 5.5 to 6.5 with sodium bicarbonate, the temperature was controlled at 10° C. to 15° C., then coupling reaction was carried out for 8 hours with the pH maintained at 5.5 to 6.5, and the resulting slurry was dried to obtain a dye compound of formula (I-1) with a hydrazone structure in the form of free acid, whose NMR spectrum and COSY spectrum were respectively shown in FIG. 1 and FIG. 2. The fabric dyed with the dye displayed a yellow hue.

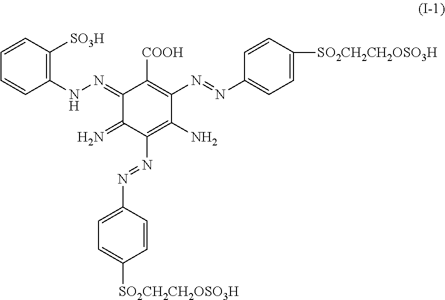

Analysis of the spectra:

There are two groups of peaks at 3.70 ppm to 4.04 ppm, which can be clearly attributed to the hydrogen atoms of methylene attached to the sulfur atom of sulfonyl group (SO₂—CH₂) , and the hydrogen atoms of methylene attached to the oxygen atom of hydrogen sulfate (HOSO₂—O—CH₂) in the reactive group (i.e. β-sulfato ethyl sulfonyl). The integral value is 8, which indicates that there are two reactive groups (i.e. β-sulfato ethyl sulfonyl).

The peaks at 7.37 ppm to 8.20 ppm are attributed to the hydrogen atoms in the aromatic region, which can be divided into two parts:

There are signals for four hydrogens at 7.30 ppm to 7.63 ppm, and the hydrogen—hydrogen related COSY spectrum and coupling constants indicate that: the signal at 7.38 ppm is split twice by the adjacent hydrogen atoms with chemical shifts of 7.44 ppm and 7.91 ppm, and the signal at 7.44 ppm is split twice by the adjacent hydrogen atoms with chemical shifts of 7.38 ppm and 7.63 ppm, indicating that the ring has the characteristic of 1,2-disubstituted structure, and the peaks can be attributed to hydrogen atoms of the component of formula (a).

There are 4 sets of hydrogen signals at 7.92 ppm to 8.19 ppm, and the COSY spectrum indicates that: the hydrogen atom with a chemical shift of 7.91 ppm and the hydrogen atom with a chemical shift of 7.98 ppm are adjacent, and the hydrogen with a chemical shift of 8.01 ppm and the hydrogen with a chemical shift of 8.20 ppm are adjacent, indicating that each ring has the characteristic of para-disubstituted structrue. Thus, the peaks can be attributed to the hydrogen atoms on the rings of the components of formula (b) and formula (c), respectively.

There should be two groups and a total of eight reactive hydrogen atoms in the structure of the yellow reactive dye, wherein, the reactive hydrogen atom of sulfonic group in the diazo component of formula (a), the reactive hydrogen atoms of hydrogen sulfates in the diazo components of formulas (b) and (c), and the reactive hydrogen atom of carboxylic acid group in the coupling component are very easy to be deuterated and combined in the water peak of solvent. Another group of hydrogen atoms attached to nitrogen atoms are present in the form of primary amine, secondary amine or imine. The reactive hydrogen atoms can be detected in DMSO-d6 solvent.

A total of 4 reactive hydrogen peaks appear in the range of 9.92 ppm to 11.46 ppm, two of which are sharp, and the other two peaks at 9.93 ppm and 10.03 ppm are broad. Two broad peaks at 9.93 ppm and 10.09 ppm can be attributed to two hydrogens of a primary amine group. Because one of the hydrogens of the primary amine group can form a hydrogen bond with the azo group on the C ring, the peak attributed to two hydrogens of the primary amine group is split into two adjacent broad peaks. The sharp peak at 11.3 ppm can be attributed to the NH hydrogen atom on the hydrazone structure. After the azo group of the component (a) is converted to the hydrazone structure, the other primary amine group is converted to imino, and an sharp peak is formed at 10.86 ppm. Therefore, the disazo yellow dye is in a relatively stable state with one side being a electron-donating hydrazone structure, and the other two sides being electron-withdrawing azo structures.

### EXAMPLES 2 to 4

Replaced the aromatic amines in step (1), step (2) with equimolar amounts of aromatic amine 1, aromatic amine 2 in table 1, proceeded in the same or similar way as in example 1 to give the dye having a hydrazone structure. The fabric was dyed with the dye obtained and a bright yellow dyeing was produced.

TABLE 1

| | | | dyes with a |
|---|---|---|---|
| | | | hydrazone |
| | | | structure (free |
| Examples | Aromatic amine 1 | Aromatic amine 2 | acid form) |
| 2 | 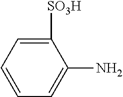 [SMILES: Nc1ccccc1S(=O)(=O)O] | 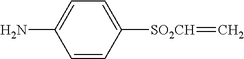 | (I-2) |
| 3 | 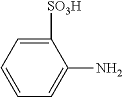 [SMILES: Nc1ccccc1S(=O)(=O)O] | 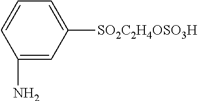 | (I-3) |
| 4 | 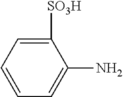 [SMILES: Nc1ccccc1S(=O)(=O)O] | 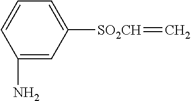 | (I-4) |

Application examples:

At 60° C., 100 g of cotton fabric was added to a dye bath consisting of 1500 g of 45 g/L sodium chloride and 2 g of the reactive dye obtained according to examples 1 to 8. After dyeing at this temperature for 45 minutes, a 20 g/L sodium carbonate solution was added, dyeing was carried out at this temperature for another 45 minutes. Then, the dyed product was rinsed, soaped for 15 minutes with a non-ionic detergent, rinsed again and dried. The characteristic values of basic dyeing properties were measured and shown in table 2.

TABLE 2
characteristic values of basic dyeing properties (values S, E, R, F)

| Items | S | E | F | R |
|---|---|---|---|---|
| Example 1 | 52.4% | 97.2% | 91.5% | 75.8% |
| Example 2 | 50.8% | 96.3% | 91.3% | 75.1% |
| Example 3 | 51.7% | 97.6% | 91.8% | 74.9% |
| Example 4 | 51.2% | 96.8% | 91.1% | 74.3% |

In the above table: dye absorptivity:

The value S represents the level of the attraction between the dye and the fabric. High S value indicates that the dye has a strong affinity for the fiber, a high up-take rate, but poor migrating property, and after dyeing the unbound dye is not easy to be washed off.

The value E represents the degree of exhaustion of the dye. High E value indicates that the dye has a high exhaustion rate, which generally reflects that the dye has high utilization efficiency, good deep-dyeing property, and low pollution level of dyeing sewage.

The value F represents the fixation rate of the dye. High F value indicates that the amount of the dye fixed by a covalent bond reaction is large, the amounts of hydrolysed dye and unreacted dye are small, and the utilization efficiency of the dye is high.

The value R represents the level of the reactivity of the dye. High R value indicates that the dye has strong ability to react covalently with the fiber under alkaline conditions, and the reaction speed is fast, however, if the reaction speed is too fast, it is likely to result in tailing problem.

According to the above table 1, the reactive dyes of the present invention have moderate S and R values, indicating that the affinity and levelness of the dyes are superb. The values E and F are high, indicating that the dyes have good deep-dyeing property, high fixation rate and utilization efficiency.

Additionally, the color fastnesses to water-washing, rubbing and perspiration-light of the dyes have been tested respectively according to the methods in GB/T3921, GB/T3920 and GB/T14576, and the results are shown in table 3:

TABLE 3
color fastnesses

| | | | | | | Color fastness | |
|---|---|---|---|---|---|---|---|
| | | | | | | to perspiration- | |
| | Water | | | | | light, cotton | |
| | washing (95° C.) | | | Fastness | | Acid | Alkaline |
| | | Stain- | Stain- | to | | per- | per- |
| | dis- | ing of | ing of | rubbing | | spiration- | spiration- |
| items | color | cotton | polyester | Dry | Wet | light | light |
| Ex- | 4~5 | 4 | 4~5 | 4~ | 3~4 | 5~6 | 5 |
| ample 1 | | | | 5 | | | |
| Ex- | 4~5 | 4 | 4 | 4~ | 3 | 5~6 | 5 |
| ample 2 | | | | 5 | | | |
| Ex- | 4~5 | 4 | 4~5 | 4~ | 3~4 | 5 | 4 |
| ample 3 | | | | 5 | | | |
| Ex- | 4~5 | 4 | 4~5 | 4~ | 3 | 5 | 4 |
| ample 4 | | | | 5 | | | |

In summary, the hydrazone structural reactive dyes according to the present invention have good overall performances, like very good deep-dyeing property, dyeing levelness, wet fastnesses, and high fixation rate, when applied for dyeing.

1. A yellow reactive dye compound, which has the formula (I): 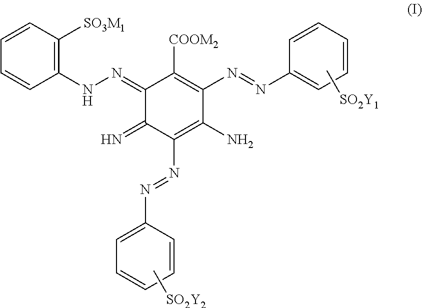
in which:
Y₁ and Y₂ independently of one another are each —CH═CH₂ or —C₂H₄OSO₃M₁, and M₁ and M₂ are H or an alkali metal.

2. The yellow reactive dye compound according to claim 1, which has one of the following formulas: 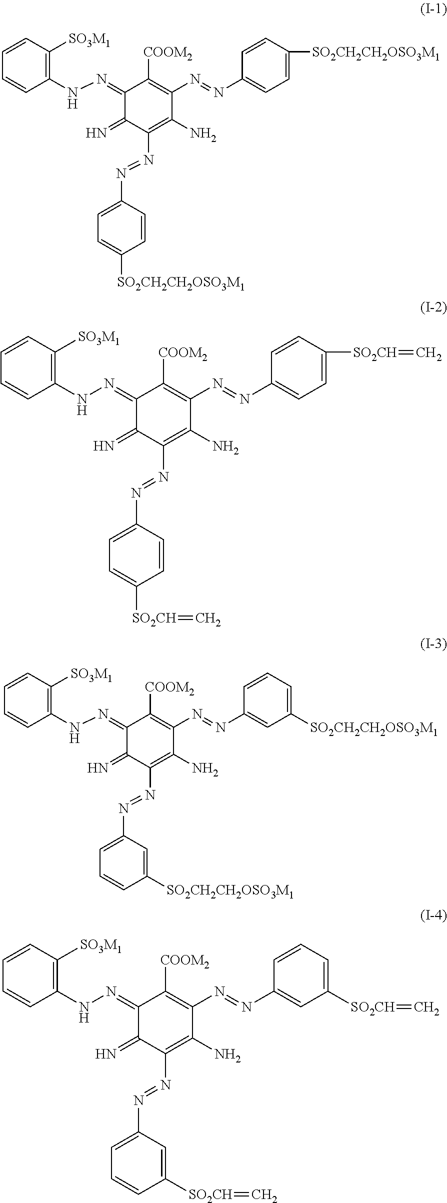
in which, M₁ and M₂ are H or an alkali metal.

3. The yellow reactive dye compound according to claim 1, in which M₁ and M₂ are H, Li, Na or K.

4. The yellow reactive dye compound according to claim 1, in which M₁ and M₂ are H or Na.

5. The yellow reactive dye compound according to claim 2, in which M₁ and M₂ are H, Li, Na or K.

6. The yellow reactive dye compound according to claim 2, in which M₁ and M₂ are H or Na.
